(19) United States
(12) Patent Application Publication
(10) Pub. No.: US 2017/0070734 A1
(43) Pub. Date: Mar. 9, 2017

(54) CODING APPARATUS, DECODING APPARATUS, AND VIDEO TRANSMISSION SYSTEM

(71) Applicant: Kabushiki Kaisha Toshiba, Tokyo (JP)

(72) Inventors: Kazuyo Kanou, Yokohama Kanagawa (JP); Atsushi Mochizuki, Kawasaki Kanagawa (JP)

(21) Appl. No.: 15/252,455

(22) Filed: Aug. 31, 2016

Related U.S. Application Data
(60) Provisional application No. 62/214,130, filed on Sep. 3, 2015.

(51) Int. Cl. H04N 19/115; H04N 19/89; H04N 19/176; H04N 19/152

(52) U.S. Cl. CPC H04N 19/115; H04N 19/152; H04N 19/89; H04N 19/176

(57) ABSTRACT

A coding apparatus according to an embodiment includes a video coding unit that compresses an input image to generate a compressed image, a reference image coding unit that stores a compressed frame generated by compressing a local decoded image, which is generated by the video coding unit by block, in a frame memory, a rate control unit that controls the reference image coding unit so that a code amount of the compressed frame is equal to or smaller than a target code amount, and a reference image decoding unit that expands the compressed frame and outputs an expanded frame to the video coding unit. The rate control unit determines whether overwrite occurs while the compressed frame of the current frame is stored in the frame memory, and changes intra-frame transition of the target code amount when there is a possibility of occurrence of the overwrite.

### CROSS-REFERENCE TO RELATED APPLICATION

This application is entitled to the benefit of Provisional Patent Application No. 62/214,130, filed on Sep. 3, 2015; the entire contents of which are incorporated herein by reference.

### FIELD

Embodiments described herein relate generally to a coding apparatus, a decoding apparatus, and a video transmission system.

### BACKGROUND

A video compression technique using inter-frame prediction has been known. Inter-frame prediction is a technique for compressing video by coding differences between frames. In compressing video using the inter-frame prediction, a memory (hereinafter referred to as a frame memory) is necessary for storing a reference image.

The frame memory preferably has a small capacity to achieve a low cost apparatus. The small capacity of the frame memory may be achieved, for example, by decreasing a data amount by compressing a reference image.

In compressing video, an image may be divided into plural blocks and the image may be compressed by block. A compression rate is preferably set by block to improve compression efficiency while maintaining image quality. When, however, the compression rate differs for each block, the data amount differs for each block, causing a different read-write speed of a block.

When the compression rate differs for each block and the read-write speed also differs for each block, the compressed image stored in the frame memory may be overwritten with another compressed data in a different frame before completion of reading of the compressed image. This is so-cal led overwrite. This problem occurs frequently especially when the capacity of the frame memory is as small as less than two frames of the compressed image.

### BRIEF DESCRIPTION OF THE DRAWINGS

FIG. 1 is a block diagram of a video transmission system according to an embodiment.

FIG. 2 is a block diagram of a compression unit included in the coding apparatus.

FIG. 3 is a block diagram of a video coding unit included in the compression unit.

FIG. 4 illustrates a local decoded image divided into plural macroblocks.

FIG. 5A illustrates intra-frame transition of a generated code amount by compressing the frame.

FIG. 5B is a memory image of a frame memory when writing of a frame of data is completed.

FIG. 6A illustrates transition of a read pointer and intra-frame transition of a target code amount.

FIG. 6B illustrates a memory image of the frame memory when overwrite occurs.

FIG. 7 is a functional block diagram of a rate control unit included in a compression unit.

FIG. 8 is a block diagram of an expansion unit included in a decoding apparatus.

FIG. 9 is a block diagram of a video decoding unit included in the expansion unit.

FIG. 10 is a functional block diagram of a rate control unit included in the expansion unit.

FIG. 11 is a flowchart of rate control processing.

FIG. 12 illustrates intra-frame transition of a generated code amount in a previous frame.

FIG. 13 illustrates expected transition of the read pointer.

FIG. 14 illustrates corrected intra-frame transition of the target code amount.

FIG. 15 illustrates corrected intra-frame transition of the target code amount.

### DETAILED DESCRIPTION

A coding apparatus according to an embodiment includes a video coding unit that compresses an input image to generate a compressed image, a reference image coding unit that stores a compressed frame generated by compressing a local decoded image, which is generated by the video coding unit by block, in a frame memory, a rate control unit that controls the reference image coding unit so that the a code amount of the compressed frame is equal to or smaller than a target code amount, and a reference image decoding unit that expands the compressed frame and outputs an expanded frame to the video coding unit. The rate control unit determines whether overwrite may occur while the compressed frame of the current frame is stored in the frame memory, and changes intra-frame transition of the target code amount when there is a possibility of occurrence of the overwrite.

Embodiments will be described below by referring to the accompanying drawings. In the drawings, the same or similar components are indicated with the same reference signs.

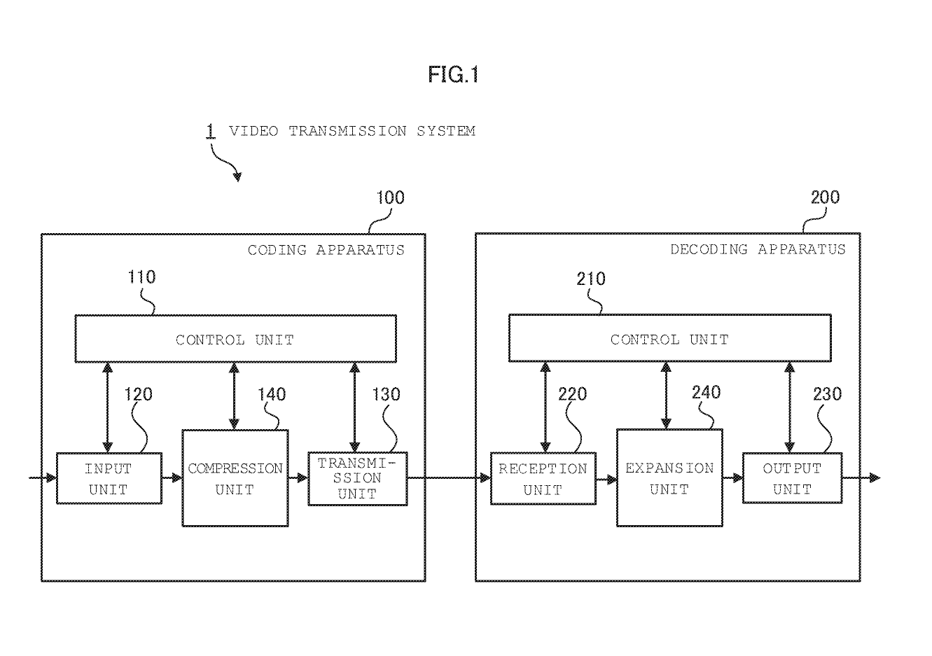

FIG. 1 is a block diagram of a video transmission system according to a video transmission system 1 according to the present embodiment. The video transmission system 1 includes a coding apparatus 100 that compresses a video image and a decoding apparatus 200 that expands the video image received from the coding apparatus 100.

The coding apparatus 100 is connected to the decoding apparatus 200 via a transmission channel. The transmission channel may be a communication cable such as a high-definition multimedia interface (HDMI) (registered trademark), or a network such as a local area network (LAN) or the Internet. The transmission channel may also be a wireless channel such as a wireless LAN. The coding apparatus 100 transmits a video stream to the decoding apparatus 200 via the transmission channel.

First, the coding apparatus 100 is described. The coding apparatus 100 includes a control unit 110, an input unit 120, a transmission unit 130, and a compression unit 140.

The control unit 110 is a processing apparatus such as a processor. The control unit 110 controls individual parts of the coding apparatus 100.

The input unit 120 is an input interface for acquiring a video signal from an external apparatus (e.g., a camera). The input unit 120 performs analog-to-digital (A-D) conversion on a video signal to generate video data and transmits the video data to the compression unit 140. The video data is formed of plural uncompressed frames (hereinafter referred to as “input images”).

The transmission unit 130 is an output interface for transmitting data to the decoding apparatus 200. The transmission unit 130 transmits the compressed video data, which has been compressed by the compression unit 140, to the decoding apparatus 200.

The compression unit 140 is formed of a processing apparatus such as a processor. For example, the compression unit 140 operates in accordance with a program stored in a read only memory (ROM) or a random access memory (RAM), both of which are not illustrated, to enable operations including “rate control processing” which will be described later.

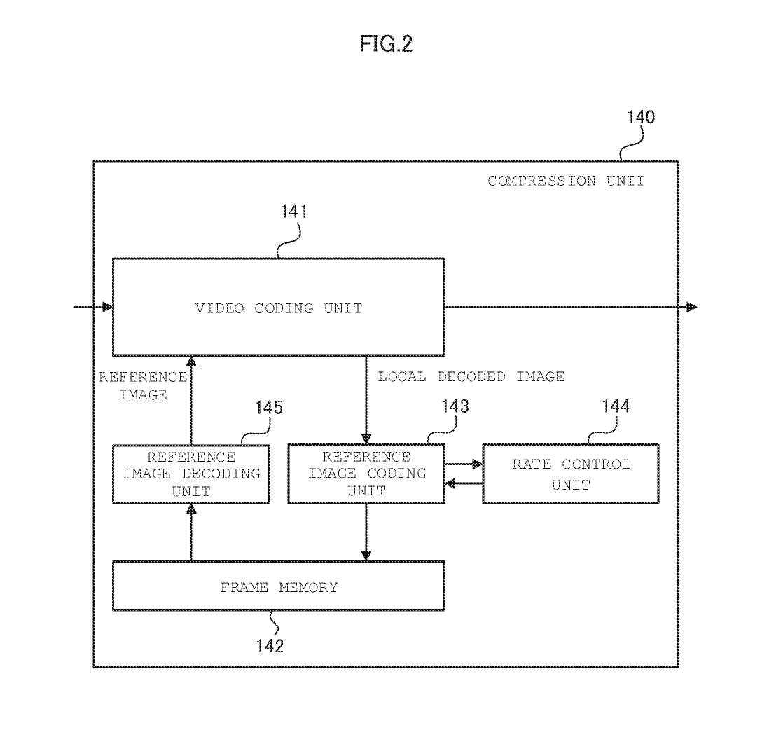

FIG. 2 is a block diagram of the compression unit 140. The compression unit 140 includes a video coding unit 141, a frame memory 142, a reference image coding unit 143, a rate control unit 144, and a reference image decoding unit 145.

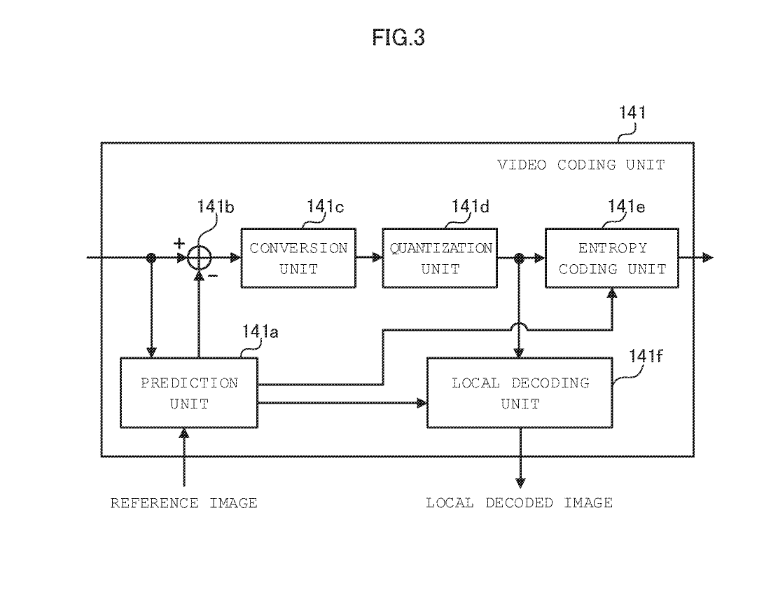

The video coding unit 141 compresses an input image based on intra-frame prediction and inter-frame prediction. For example, the video coding unit 141 compresses an input image in accordance with H.264/AVC. FIG. 3 illustrates an example structure of the video coding unit 141. The video coding unit 141 includes a prediction unit 141a, an adder 141b, a conversion unit 141c, a quantization unit 141d, an entropy coding unit 141e, and a local decode unit 141f.

The prediction unit 141a generates a prediction image based on the intra-frame and inter-frame prediction. For example, the prediction unit 141a executes motion search between a reference image acquired by the reference image decoding unit 145 and the input image and generates a motion vector. The motion search may be executed by a searching method, such as block matching or a gradient method. The prediction unit 141a outputs a motion vector to the entropy coding unit 141e and generates a motion compensation image based on the motion vector and the reference image. The prediction unit 141a then outputs the motion compensation image to the adder 141b as a prediction image.

The adder 141b generates prediction error data. The prediction error data is difference data between the prediction image and the input image. The adder 141b outputs the prediction error data to the conversion unit 141c.

The conversion unit 141c and the quantization unit 141d compress the prediction error data. For example, the conversion unit 141c converts the prediction error data into spatial frequency domain data by orthogonal transform, such as discrete cosine transform (DCT). The quantization unit 141d cuts off a high order conversion coefficient having low influence on human vision among the conversion coefficients generated by the conversion unit 141c. The quantization unit 141d then outputs data subjected to quantization (hereinafter referred to as quantized data) to the entropy coding unit 141e.

The entropy coding unit 141e executes variable length coding (VLC) on the quantized data and the motion vector. The entropy coding unit 141e outputs the coded data to the transmission unit 130.

The local decode unit 141f generates a local decoded image by executing, for example, inverse transform or inverse quantization. The local decoded image is a reproduction of the decoded image that has been generated on the decoding side and reproduced on the coding side.

Referring to FIG. 2 again, the frame memory 142 is formed of a storage apparatus capable of reading/writing of data, such as a dynamic random access memory (DRAM), a static random access memory (SRAM), a semiconductor memory, or a hard disc. The frame memory 142 stores the local decoded image that has been compressed by the reference image coding unit 143 (hereinafter referred to as a compressed frame). The frame memory 142 is a ring buffer. A data reading position and a data writing position are managed by a read pointer and a write pointer, respectively.

A memory size Sa of the frame memory 142 is larger than a frame of a target frame size Sb. In this case, the memory size Sa may be smaller than two frames of the target frame size Sb. The target frame size Sb represents a data amount set by the reference image coding unit 143 as a compression target in compressing frames, that is, a target code amount of a frame of the compressed frame. The frame memory 142 is a part of the compression unit 140 in FIG. 2, but the frame memory 142 may be disposed outside the compression unit 140.

The reference image coding unit 143 compresses the local decoded image to generate the compressed frame. The reference image coding unit 143 then stores the compressed frame in the frame memory 142. The reference image coding unit 143 compresses the local decoded image by block. The reference image coding unit 143 compresses the local decoded image so that the data amount of the compressed frame does not exceed the target frame size Sb.

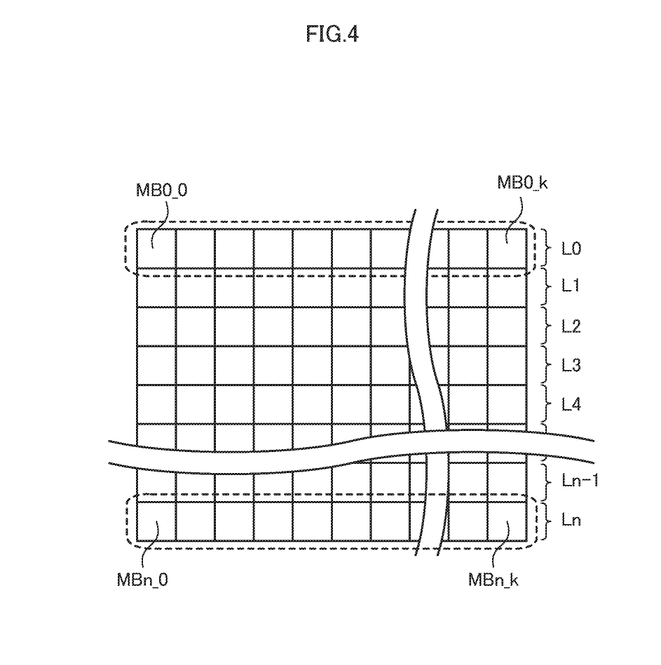

FIG. 4 illustrates a local decoded image divided into plural macroblocks. Each cell (MB0_0 to MBn_k) in the drawing represents a macroblock, where n and k are arbitrary integers. Here, the macroblock is a unit block for compression processing. For example, the macroblock may be a rectangular block of 4×4 pixels to 16×16 pixels. In the present embodiment, the reference image coding unit 143 executes the compression processing for each macroblock row. The macroblock row represents a line of macroblock. In the example of FIG. 4, lines L0 to Ln individually represent the macroblock row. The macroblock row is also a block. Hereinafter, the macroblock row is referred to as an MB row.

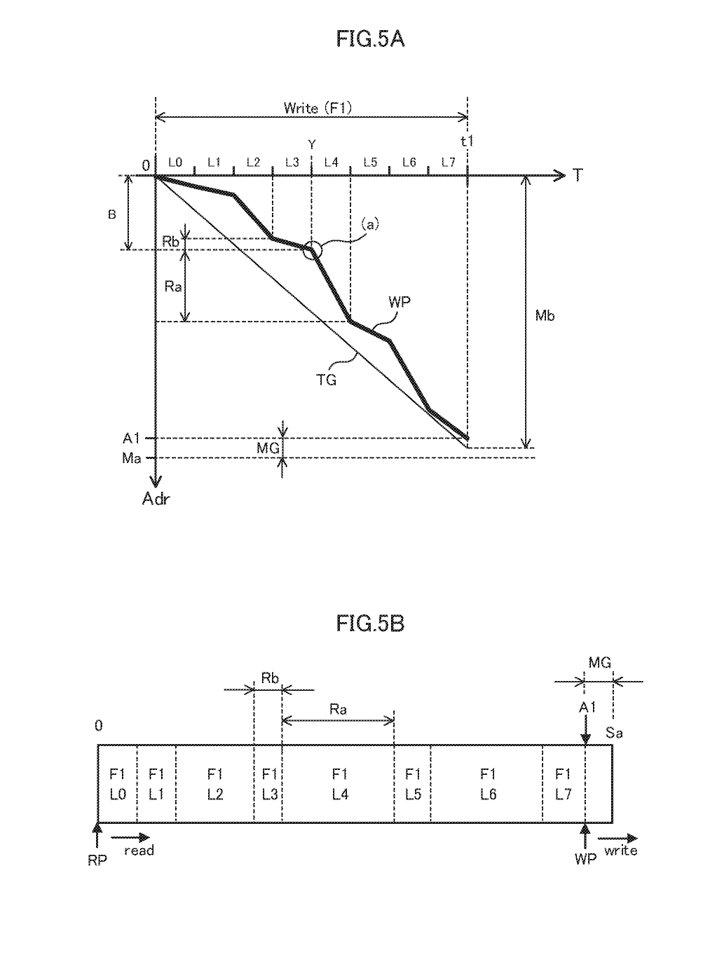

The reference image coding unit 143 compresses each block (MB row) based on a compression rate received from the rate control unit 144. FIG. 5A illustrates intra-frame transition of a generated code amount in compressing a frame F1. In one example of the present embodiment, the frame F1 is formed of seven MB rows L0 to L7. In the drawing, the vertical axis represents an address of the frame memory 142 and the horizontal axis represents time. A line WP represents transition of the write pointer. In the following description, the transition of the write pointer WP indicates the intra-frame transition of the generated code amount.

The reference image coding unit 143 stores the compressed MB row in the frame memory 142 each time the MB row is compressed. FIG. 5B is a memory image of the frame memory 142 when writing of the frame F1 is completed.

Here, blocks L3 and L4 are considered. The block L3 includes monotonous pattern data which can easily be compressed. Accordingly, the block L3 has a high compression rate. As a result, a generated code amount Rb is small. Meanwhile, the block L4 includes complicated pattern data which is not easily compressed. Accordingly, the block L4 has a low compression rate. As a result, a generated code amount Ra is large. Thus, the data amount (the generated code amount) of the blocks differ after compression although the blocks have the same size before compression.

The compression rate of the blocks can also be determined according to the intra-frame transition WP of the generated code amount. The write pointer WP of FIG. 5A is considered. The block L3 has a high compression rate, so that the generated code amount Rb is small. Therefore, the tilt is small. Meanwhile, the block L4 has a low compression rate, so that the generated code amount Ra is large. Therefore, the tilt is large. Thus, the tilt of the intra-frame transition WP of the generated code amount becomes smaller as the compression rate increases (i.e., the generated code amount decreases), and becomes larger as the compression rate decreases (i.e., the generated code amount increases).

The reference image coding unit 143 transmits information of the intra-frame transition of the generated code amount to the rate control unit 144. For example, the reference image coding unit 143 transmits a block of the generated code amount to the rate control unit 144 each time the compression of the block (MB row) ends. The information of the intra-frame transition of the generated code amount is not limited to the generated code amount. The reference image coding unit 143 may transmit an end-of-writing address indicated by the write pointer WP to the rate control unit 144 each time the compression of the block (MB row) ends. Needless to say, the reference image coding unit 143 can transmit more than one block of the generated code amount or the end-of-writing address, instead of a single block, to the rate control unit 144.

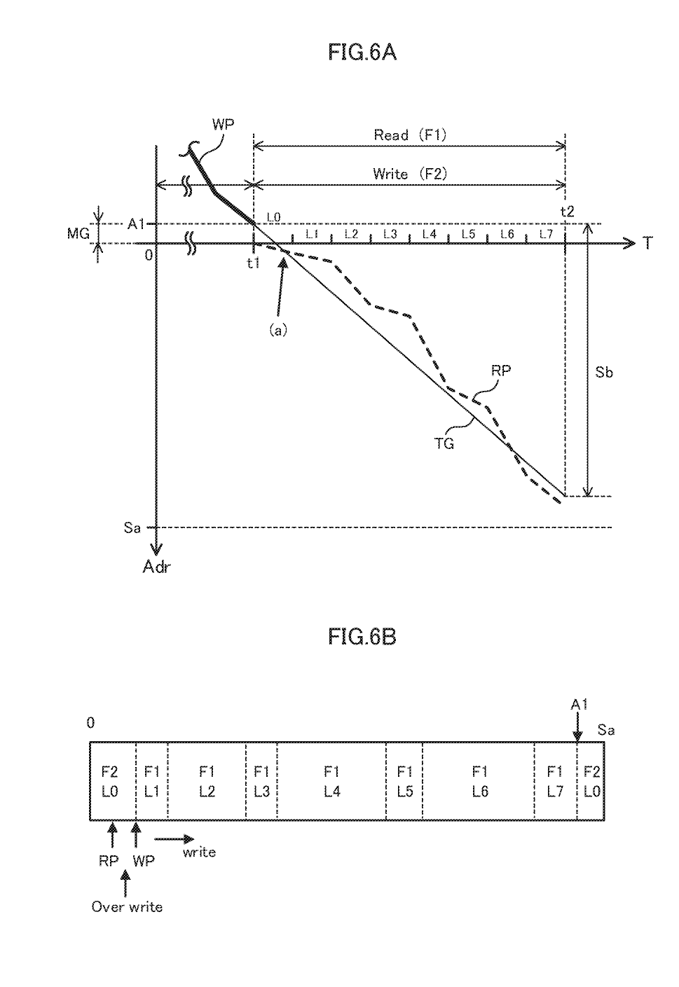

Referring to FIG. 2 again, the rate control unit 144 controls the compression rate of the reference image coding unit 143 to prevent occurrence of overwrite in the frame memory 142. FIG. 6A illustrates predicted transition of a read pointer RP and intra-frame transition TG of a target code amount. The line RP represents the predicted transition of the read pointer RP when the reference image decoding unit 145 reads the frame F1. The line TG represents intra-frame transition of the target code amount generated in compressing the frame by the reference image coding unit 143. In FIG. 6A, a reference image decoding unit 145 starts reading of the frame F1 simultaneously with the end of writing of the frame F1. When the reading speed and the writing speed for unit data are the same, the transition of the read pointer RP runs similarly to the transition of the write pointer WP illustrated in FIG. 5A.

As illustrated in FIG. 6A, the intra-frame transition TG of the target code amount is set as a straight line running to the target frame size Sb. When the code is generated to the target code amount, the write pointer WP changes along the line TG. In this case, the write pointer WP reaches the read pointer RP while the block L0 of the frame F2 is written, that is, at a point (a) in FIG. 6A. This indicates that overwrite may occur at the point (a). FIG. 6B is a memory image of the frame memory 142 when overwrite occurs.

The rate control unit 144 controls the compression rate of the current frame to prevent occurrence of overwrite. The current frame refers to a frame which is currently a target for executing compression by the reference image coding unit 143. Here, the rate control unit 144 then controls the compression rate of the current frame based on the intra-frame transition of the generated code amount of a frame located immediately before the current frame (hereinafter referred to as the previous frame). In the example of FIG. 6A, the rate control unit 144 controls the compression rate of the frame F2 based on the intra-frame transition of the generated code amount of the frame F1 (indicated by the line RP of FIG. 6A). Accordingly, the rate control unit 144 prevents the occurrence of overwrite. Controlling the compression rate by the rate control unit 144 will be described later.

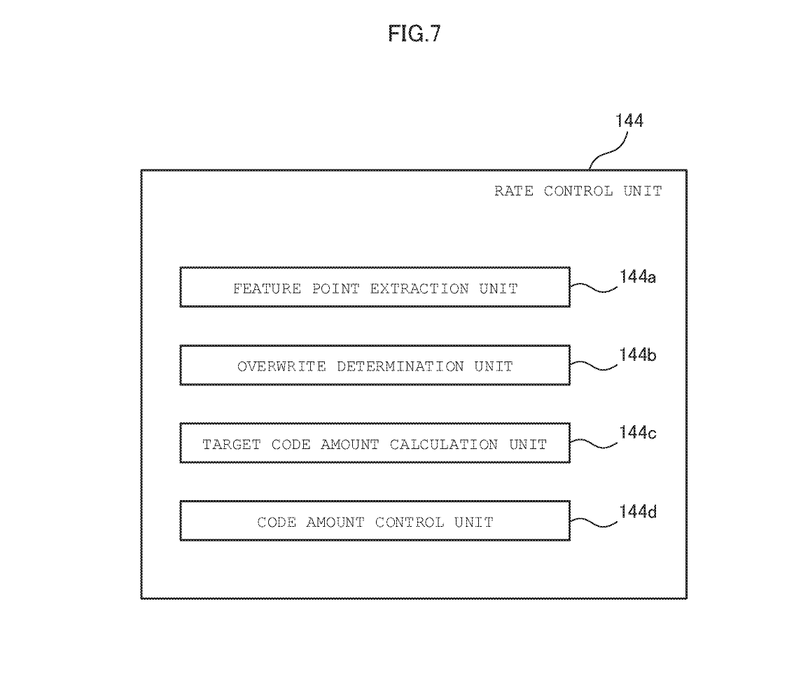

FIG. 7 is a functional block diagram of the rate control unit 144. The rate control unit 144 has functions including a feature point extraction unit 144a, an overwrite determination unit 144b, a target code amount calculation unit 144c, and a code amount control unit 144d. These functions will be described later in connection with rate control processing.

Referring to FIG. 2 again, the reference image decoding unit 145 expands the compressed frame stored in the frame memory 142. The expanded image turns a reference image to be used for the inter-frame prediction by the video coding unit 141. The reference image decoding unit 145 transmits the reference image to the video coding unit 141.

Next, the decoding apparatus 200 is described. The decoding apparatus 200 includes, as illustrated in FIG. 1, a control unit 210, a reception unit 220, an output unit 230, and an expansion unit 240.

The control unit 210 is formed of a processing apparatus such as a processor. The control unit 210 controls individual parts of the decoding apparatus 200.

The reception unit 220 is a communication interface for receiving video data from the coding apparatus 100. The reception unit 220 receives compressed video data and transmits the compressed video data to the expansion unit 240.

The output unit 230 is an output interface to output video information to the output apparatus (e.g., liquid crystal display). The output unit 230 outputs the decoded image that has been decoded by the expansion unit 240 to the output apparatus.

The expansion unit 240 is formed of a processing apparatus such as a processor. For example, the expansion unit 240 operates in accordance with the program stored in the ROM or RAM, which is not illustrated, to enable various operations including rate control processing which will be described later.

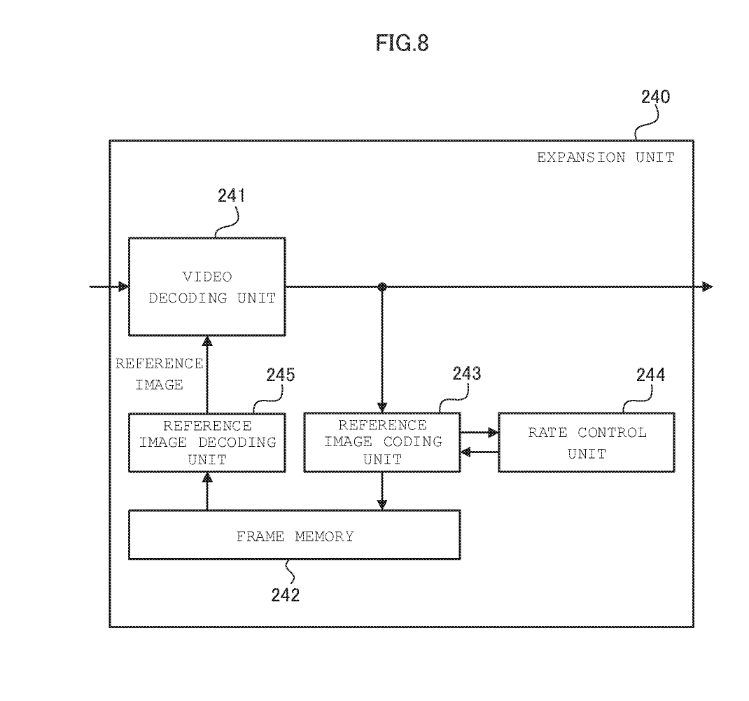

FIG. 8 is a block diagram of the expansion unit 240. The expansion unit 240 includes a video decoding unit 241, a frame memory 242, a reference image coding unit 243, a rate control unit 244, and a reference image decoding unit 245.

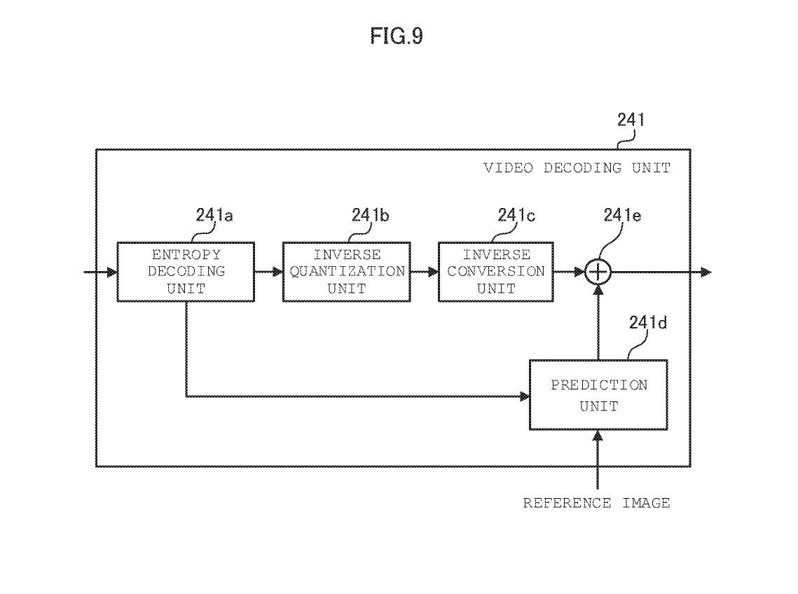

The video decoding unit 241 decodes data received from the reception unit 220. The video decoding unit 241 expands the received data using an expansion method corresponding to the compression method used by the video coding unit 141. FIG. 9 illustrates an example structure of the video decoding unit 241. The video decoding unit 241 includes an entropy decoding unit 241a, an inverse quantization unit 241b, an inverse transform unit 241c, a prediction unit 241d, and an adder 241e.

The entropy decoding unit 241a decodes the motion vector and the quantized data. The motion vector is output to the prediction unit 241d, and the quantized data is output to the inverse quantization unit 241b.

The inverse quantization unit 241b and the inverse transform unit 241c decode the prediction error data. Specifically, the inverse quantization unit 241b obtains the quantized data from the entropy decoding unit 241a. The inverse quantization unit 241b then performs inverse quantization of the obtained data. The inverse transform unit 241c extracts the prediction error data from the data that has been subjected to inverse quantization.

The prediction unit 241d generates the prediction image based on the intra-frame prediction and the inter-frame prediction. For example, the prediction unit 241d acquires a reference image from the reference image decoding unit 245 and a motion vector from the entropy decoding unit 241a. The prediction unit 241d then generates the prediction image based on the reference image and the motion vector.

The adder 241e adds the prediction error data and the prediction image to generate the decoded image. The adder 241e then outputs the decoded image to the output unit 230 and the reference image coding unit 243.

Referring to FIG. 8 again, the frame memory 242 is formed of a storage apparatus capable of reading/writing of data, such as the DRAM or the SRAM. The frame memory 242 stores the decoded image that has been compressed by the reference image coding unit 243. The frame memory 242 is a ring buffer. Data reading positions and data writing positions are managed with the read pointer and the write pointer, respectively. The memory size Sa of the frame memory 142 is larger than a frame of the target frame size Sb. In this case, the memory size Sa may be smaller than two frames of the target frame size Sb. The frame memory 242 may be disposed outside the expansion unit 240, although the frame memory 242 is illustrated as part of the expansion unit 240 in FIG. 8.

The reference image coding unit 243 compresses the decoded image and stores the decoded image in the frame memory 242. The reference image coding unit 243 compresses the decoded image using the same compressing method as used by the reference image coding unit 143 of the coding apparatus 100. Thus, the reference image of the decoding apparatus 200 and the reference image of the coding apparatus 100 can match each other.

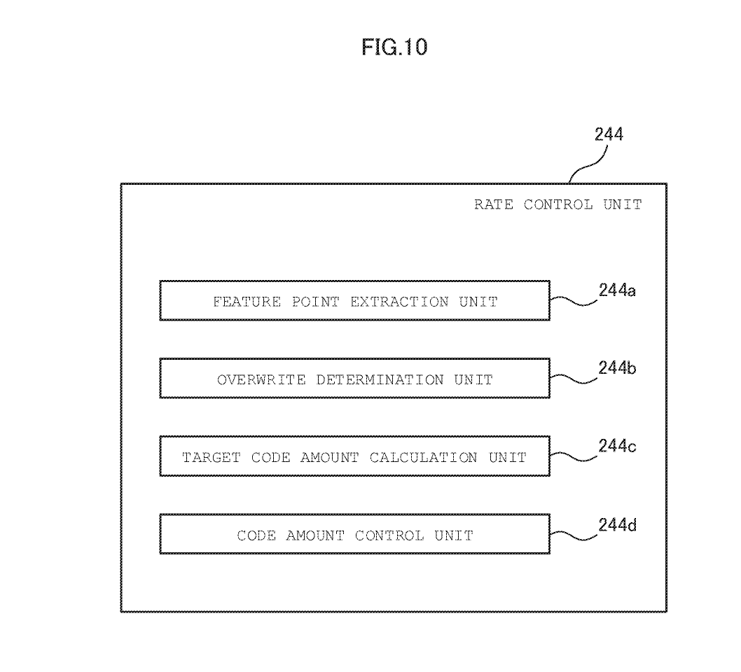

The rate control unit 244 controls the compression rate in the reference image coding unit 243 to prevent occurrence of overwrite in the frame memory 242. The rate control unit 244 operates similarly to the rate control unit 144. FIG. 10 is a functional block diagram of the rate control unit 244. The rate control unit 244 has functions including a feature point extraction unit 244a, an overwrite determination unit 244b, a target code amount calculation unit 244c, and a code amount control unit 244d. These functions are the same as the functions included in the rate control unit 144.

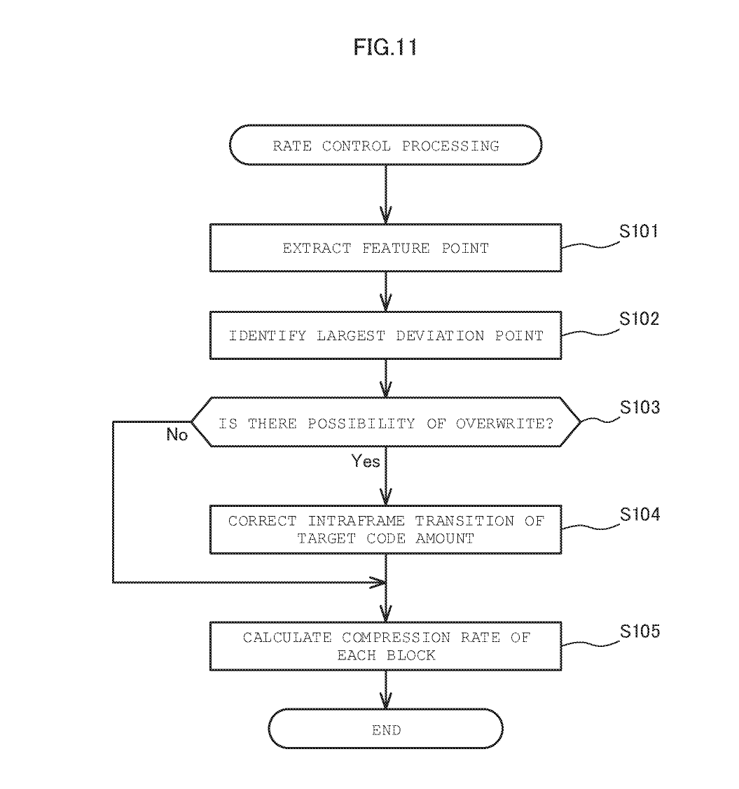

Next, the operation of the rate control unit 144 is described. For example, the rate control unit 144 starts rate control processing in accordance with the instruction from an upper control unit. The rate control processing is performed repeatedly. FIG. 11 is a flowchart of the rate control processing.

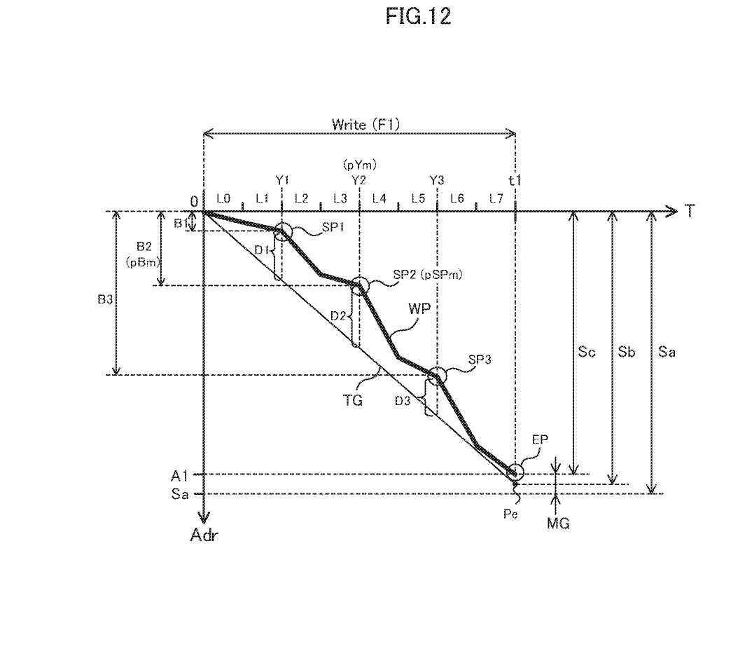

The feature point extraction unit 144a extracts a feature point from the intra-frame transition WP of the generated code amount of the previous frame (S101). The feature point represents a point at which the compression rate changes to start decreasing, or the tilt changes to start increasing, in the intra-frame transition WP of the generated code amount. FIG. 12 illustrates the intra-frame transition WP of the generated code amount of the frame F1. In the example of FIG. 12, the feature points are SP1, SP2, and SP3 where the tilt starts to increase.

Many methods are available for extracting feature points. For example, the feature point extraction unit 144a can extract feature points by the following method. First, the feature point extraction unit 144a selects a block (MB row). The feature point extraction unit 144a compares the generated code amounts between the selected block and the block located immediately previous to the selected block. When the selected block has a larger generated code amount than the previous block, the feature point extraction unit 144a determines that the feature point is the start point of the selected block. The feature point extraction unit 144a otherwise does not determine that the feature point is the start point of the selected block.

This processing is described in detail by referring to FIG. 5A. The feature point extraction unit 144a selects the block L4 of the frame F1. Here, the feature point extraction unit 144a then compares the generated code amounts Ra and Rb between the block L4 and the block L3 that is located immediately previous to the block L4. Since the generated code amount Ra is larger than the generated code amount Rb in the example of FIG. 5A, the feature point extraction unit 144a determines that the start point (indicated by point (a) of FIG. 5A) of the block L4 is the feature point.

The feature point extraction unit 144a then stores information representing the position of the feature point in a list which is not illustrated. For example, the feature point extraction unit 144a determines that the feature point is the point (a) of FIG. 5A and stores a position Y and an accumulated code amount B in the list as the information indicating the position of the feature point. The position Y is a position in the time axis direction relative to the start time of writing the frame F1 (previous frame). The code amount B is an accumulated data amount relative to the start time of writing the frame F1 (previous frame).

The feature point extraction unit 144a extracts all feature points from the intra-frame transition WP of the generated code amount of the previous frame, and stores such information in the list which is not illustrated. In the example of FIG. 12, the feature point extraction unit 144a extracts three points SP1, SP2, and SP3 as the feature points. The feature point extraction unit 144a stores the position Y1 and the accumulated code amount B1 as SP1 information, the position Y2 and the accumulated code amount B2 as SP2 information, and the position Y3 and the accumulated code amount B3 as SP3 information.

Referring to FIG. 11 again, the overwrite determination unit 144b identifies the largest deviation point pSPm among the feature points extracted in S101 (S102). The largest deviation point pSPm is one of the feature points extracted in S101 and having the largest distance from the intra-frame transition TG of the target code amount. Here, the intra-frame transition TG of the target code amount is a straight line that changes linearly to the target frame size Sb. In the example of FIG. 12, the intra-frame transition TG of the target code amount is a straight line between the origin 0 and the point Pe.

The largest deviation point pSPm is described in the example of FIG. 12. The feature points SP1 to SP3 are apart from the intra-frame transition TG of the target code amount by distances D1 to D3, respectively, as illustrated in FIG. 12. Among them, the largest distance is D2. In the example of FIG. 12, the overwrite determination unit 144b determines that the largest deviation point pSPm is SP2. The overwrite determination unit 144b stores a position pYm and an accumulated code amount pBm as the information of the largest deviation point pSPm in the RAM which is not illustrated.

Referring to FIG. 11 again, the overwrite determination unit 144b determines whether the overwrite may possibly occur while the compressed frame of the current frame is stored in the frame memory 142 (S103). Here, the overwrite determination unit 144b determines the possibility of occurrence of the overwrite based on the intra-frame transition WP of the generated code amount of the previous frame.

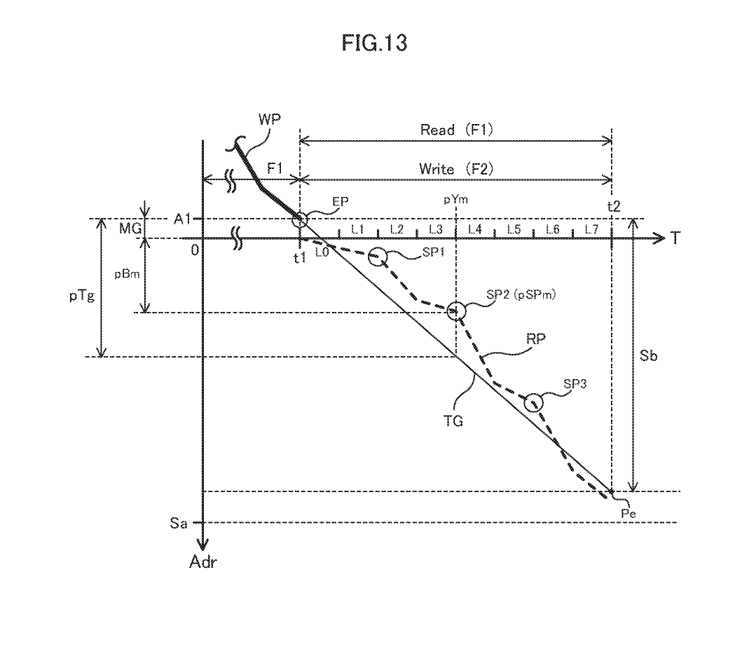

This processing is described in detail by referring to FIG. 13. The line RP in the drawing represents the predicted transition of the read pointer based on the intra-frame transition WP of the generated code amount of the previous frame. First, the overwrite determination unit 144b acquires the accumulated code amount pBm of the largest deviation point pSPm from the RAM which is not illustrated. The overwrite determination unit 144b calculates a margin MG based on the information of the intra-frame transition WP of the generated code amount of the previous frame. The margin MG represents a difference between the compressed frame size Sc and the memory size Sa of the previous frame. Moreover, the overwrite determination unit 144b further calculates the target code amount pTg of the current frame at the largest deviation point pSPm. For example, the overwrite determination unit 144b calculates the target code amount pTg based on the intra-frame transition TG of the target code amount and the position pYm of the largest deviation point pSPm of the current frame.

The overwrite determination unit 144b compares the accumulated code amount pBm added by the margin MG and the target code amount pTg. If the value accumulated code amount pBm added by the margin MG is smaller than the target code amount pTg, the overwrite determination unit 144b determines that there is a possibility of occurrence of the overwrite. If the value of the accumulated code amount pBm added by the margin MG is larger than the target code amount pTg, the overwrite determination unit 144b determines that there is no possibility of occurrence of the overwrite. When there is no possibility of occurrence of the overwrite (S103: No), the rate control unit 244 advances the process to S105.

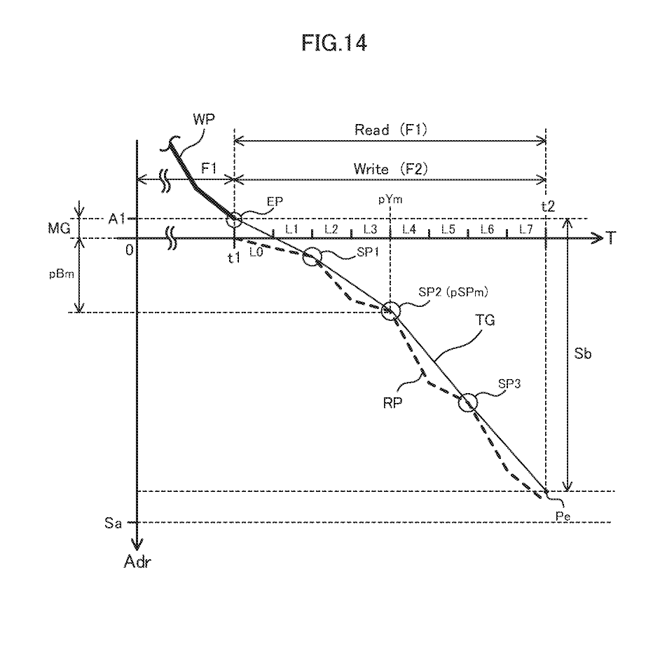

When there is a possibility of occurrence of the overwrite (S103: Yes), the target code amount calculation unit 144c corrects the intra-frame transition TG of the target code amount of the current frame to prevent occurrence of the overwrite (S104). For example, the target code amount calculation unit 144c may determine that the transition derived by connecting the feature points is a new intra-frame transition TG of the target code amount. FIG. 14 illustrates corrected intra-frame transition TG of the target code amount. In the example of FIG. 14, the intra-frame transition TG of the target code amount is indicated by a line running from the end-of-writing point of the previous frame EP through the feature points SP1 to SP3 to the end-of-transition point Pe before correction. Here, the target code amount Sb of a frame is not changed. By comparing the lines TG and RP, it is clear that the number of blocks having a high compression rate (lines having a smaller tilt) is decreased by connecting the feature points.

The intra-frame transition of the target code amount may be reconsidered for each MB row (plural blocks) for more correct control of the compression rate. Correction for each MB row (plural blocks) leads to a new target code amount determined by connecting the feature points with points obtained from the actual code amount that has been generated and accumulated. To minimize the difference in image quality of the frame, the tilt of the intra-frame transition of the target code amount may not be larger than a particular value (e.g., a tilt of a line between the end-of-writing point EP of the previous frame and the end-of-transition point Pe) after the correction. Moreover, correction of the target code amount is not necessary when the code amount having been generated and accumulated of a block is not larger than the accumulated code amount at the corresponding position of the previous frame, because the possibility of occurrence of the overwrite is low in that case.

The code amount control unit 144d controls the code amount generated by the reference image coding unit 143 so that the code amount generated by the reference image coding unit 143 is equal to or smaller than the intra-frame transition TG of the target code amount (S105). For example, the code amount control unit 144d determines a quantization coefficient in compressing each block by the reference image coding unit 143. The code amount control unit 144d transmits the calculated compression rate to the reference image coding unit 143. The reference image coding unit 143 then compresses each block based on the calculated compression rate calculated by the code amount control unit 144d.

When the transmission of the compression rate ends, the rate control unit 144 ends the rate control processing. The rate control processing executed by the rate control unit 244 is equal to the rate control processing described above. Here, the feature point extraction unit 144a, the overwrite determination unit 144b, the target code amount calculation unit 144c, the code amount control unit 144d, the frame memory 142, and the reference image coding unit 143 can respectively be replaced by the feature point extraction unit 244a, the overwrite determination unit 244b, the target code amount calculation unit 244c, the code amount control unit 244d, the frame memory 242, and the reference image coding unit 243.

According to the present embodiment, the rate control units 144 and 244 determine whether the overwrite may possibly occur when the compressed frame of the current frame is stored in the frame memory 142 or 242. If there is a possibility of occurrence of the overwrite, the rate control units 144 and 244 change the intra-frame transition TG of the target code amount based on the intra-frame transition WP of the generated code amount of the previous frame. Thus, the overwrite does not occur even when the frame memories 142 and 242 have small capacities.

The rate control units 144 and 244 extract, as the feature points, the points at which the compression rate changes to start decreasing from the intra-frame transition WP of the generated code amount of the previous frame. When there is a possibility of occurrence of the overwrite, the rate control units 144 and 244 use the transition derived from the connected feature points as the intra-frame transition TG of the target code amount of the current frame. This decrease the number of blocks that have to have a high compression rate, preventing occurrence of blocks having extremely poor image quality. The connected feature points enable moderate change of the compression rate, preventing a large difference in image quality between adjacent blocks.

The present embodiment has been provided as an example to which various changes and modifications are available. For example, the target code amount calculation unit 144c determines that the transition derived from the connected feature points is the intra-frame transition of the target code amount of the current frame in S104 above. However, the target code amount calculation unit 144c may select other feature points that satisfy predetermined criteria among the plural feature points extracted in S101 as the feature points to be used for correcting the intra-frame transition of the target code amount TG. The target code amount calculation unit 144c then may determine that the transition derived by connecting the selected feature points is the intra-frame transition TG of the target code amount.

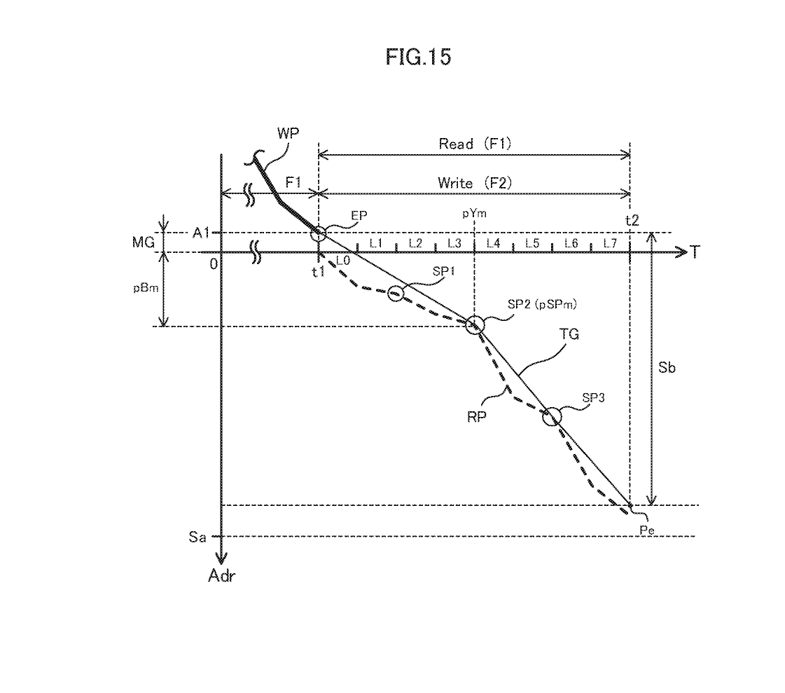

This processing is described in detail by referring to FIG. 15. In S101, SP1 to SP3 are extracted as the feature points, and in S102, SP2 is identified as the largest deviation point pSPm. If SP1 is positioned below the straight line between the end-of-writing point EP of the previous frame and the largest deviation point pSPm, the target code amount calculation unit 144c excludes SP1 from SP1 to SP3 and uses SP2 and SP3 for correction of the transition TG. The target code amount calculation unit 144c then determines the line connecting EP, SP2, SP3, and Pe as the intra-frame transition TG of the target code amount calculation. This processing is also available for the target code amount calculation unit 244c.

In S104 above, the target code amount calculation unit 144c does not change a frame of the target code amount Sb before and after the correction of the intra-frame transition TG of the target code amount when changing the transition TG. Alternatively, the target code amount calculation unit 144c may change a frame of the target code amount Sb before and after the correction of the transition TG.

In S105 above, the code amount control unit 144d controls the code amount generated by the reference image coding unit 143 by transmitting compression rate information of each block to the reference image coding unit 143. Alternatively, the code amount control unit 144d may control the code amount generated by the reference image coding unit 143 by transmitting information of the intra-frame transition TG of the target code amount of the current frame to the reference image coding unit 143. Here, the reference image coding unit 143 may then change the compression rate of each block based on the information of the intra-frame transition TG of the target code amount of the current frame. This processing is also available for the code amount control unit 244d and the reference image coding unit 243.

In the present embodiment above, the MB row is a unit block for compression by the reference image coding unit 143. The unit block for compression may not be the MB row. For example, the unit block for compression performed by the reference image coding unit 143 may be a block obtained by dividing the image by predetermined size. This processing is also available for the reference image coding unit 243.

The coding apparatus 100 and the decoding apparatus 200 may be finished products, such as a camera, a TV, a player, a recorder, a personal computer, a land-line phone, a mobile phone, a smartphone, a tablet terminal, a personal digital assistant (PDA), or a game machine. The coding apparatus 100 and the decoding apparatus 200 may also be semiconductor components, such as a semiconductor chip or a semiconductor substrate.

The coding apparatus 100 and the decoding apparatus 200 according to the present embodiment may be realized by a dedicated computer system or by a normal computer system. For example, the coding apparatus 100 and the decoding apparatus 200 may be formed in such a manner that the program used to execute the above operations is stored in and distributed as a readable recording medium, such as an optical disc, a semiconductor memory, a magnetic tape, or a flexible disc, and such a program is installed on the computer to execute the above processing. The above program may be stored in a disc apparatus included in a server apparatus on a network such as the Internet and downloaded, for example, on the computer. The above-described function may be realized in cooperation with an operating system (OS) and application software. In this case, the components other than the OS may be stored in and distributed as a medium or stored in a server apparatus and downloaded, for example, on the computer.

While certain embodiments have been described, these embodiments have been presented by way of example only, and are not intended to limit the scope of the inventions. Indeed, the novel apparatus and methods described here in may be embodied in a variety of other forms; furthermore, various omissions, substitutions and changes in the form of the apparatus and methods described herein may be made without departing from the spirit of the inventions. The accompanying claims and there equivalents are intended to cover such forms of modifications as would fall within the scope and spirit of the inventions.

What is claimed is:

1. A coding apparatus comprising:
a video coding unit configured to compress an input image to generate a compressed image;
a reference image coding unit configured to store a compressed frame generated by compressing a local decoded image, which is generated by the video coding unit by block, in a frame memory;
a rate control unit configured to control the reference image coding unit so that a code amount of the compressed frame is equal to or smaller than a target code amount; and
a reference image decoding unit configured to expand the compressed frame and output an expanded frame to the video coding unit, wherein
the rate control unit determines whether overwrite occurs while the compressed frame of a current frame is stored in the frame memory, and
the rate control unit changes an intra-frame transition of the target code amount when the overwrite occurs.

2. The coding apparatus according to claim 1, wherein
the rate control unit determines whether the overwrite occurs based on the intra-frame transition of a generated code amount of a previous frame.

3. The coding apparatus according to claim 2, wherein
the rate control unit changes the intra-frame transition of the target code amount of the current frame based on the intra-frame transition of the generated code amount of the previous frame when the overwrite occurs.

4. The coding apparatus according to claim 3, wherein
the rate control unit extracts a plurality of feature points at which a compression rate starts to decrease from the intra-frame transition of the generated code amount of the previous frame, and
the rate control unit determines the intra-frame transition of the target code amount of the current frame based on the feature points when the overwrite occurs.

5. The coding apparatus according to claim 3, wherein
the rate control unit extracts a plurality of feature points at which a compression rate starts to decrease from the intra-frame transition of the generated code amount of the previous frame when the overwrite occurs, and
the rate control unit determines the intra-frame transition of the target code amount of the current frame based on the extracted feature points.

6. The coding apparatus according to claim 3, wherein
the reference image coding unit is able to change a compression rate by block, and
the rate control unit changes the compression rate by block so as to satisfy the intra-frame transition of the target code amount of the current frame.

7. The coding apparatus according to claim 6, wherein
the block is a macroblock row.

8. The coding apparatus according to claim 1, wherein
the target code amount per a frame is fixed.

9. The coding apparatus according to claim 8, comprising the frame memory.

10. The coding apparatus according to claim 9, wherein
the frame memory has a capacity larger than the target code amount of one compressed frame and smaller than the target code amount of two compressed frames.

11. A decoding apparatus, comprising:
a video coding unit configured to expand a compressed image to generate a decoded image;
a reference image coding unit configured to store a compressed frame generated by compressing the decoded image by block;
a rate control unit configured to control the reference image coding unit so that the code amount of the compressed frame is equal to or smaller than a target code amount; and
a reference image decoding unit configured to expand the compressed frame and output an expanded frame to the video coding unit, wherein
the rate control unit determines whether overwrite occurs while the compressed frame of a current frame is stored in the frame memory, and
the rate control unit changes intra-frame transition of the target code amount when the overwrite occurs.

12. The decoding apparatus according to claim 11, wherein
the rate control unit determines whether the overwrite occurs based on intra-frame transition of a generated code amount of a previous frame when the compressed frame of the current frame is stored in the frame memory.

13. The decoding apparatus according to claim 12, wherein
the rate control unit changes the intra-frame transition of the target code amount of the current frame based on the intra-frame transition of the generated code amount of the previous frame when the overwrite occurs.

14. The decoding apparatus according to claim 13, wherein
the rate control unit extracts a plurality of feature points at which a compression rate starts to decrease from the intra-frame transition of the generated code amount of the previous frame, and
the rate control unit determines the intra-frame transition of the target code amount of the current frame based on the feature points when the overwrite occurs.

15. The decoding apparatus according to claim 13, wherein
the rate control unit extracts a plurality of feature points at which a compression rate starts to decrease from the intra-frame transition of the generated code amount of the previous frame when the overwrite occurs, and
the rate control unit determines the intra-frame transition of the target code amount of the current frame based on the extracted feature points.

16. The decoding apparatus according to claim 13, wherein
the reference image coding unit is able to change a compression rate by block, and
the rate control unit changes the compression rate by block so as to satisfy the intra-frame transition of the target code amount of the current frame.

17. The decoding apparatus according to claim 16, wherein
the block is a macroblock row.

18. The decoding apparatus according to claim 11, wherein
the target code amount per frame is fixed.

19. The decoding apparatus according to claim 18, further comprising the frame memory, wherein
the frame memory has a capacity larger than the target code amount of one compressed frame and smaller than the target code amount of two compressed frames.

20. A video transmission system, comprising:
a coding apparatus configured to compress an input image and transmits a compressed image; and
a decoding apparatus configured to expand the compressed image transmitted by the coding apparatus, wherein
the coding apparatus includes
a video coding unit configured to compress the input image to generate the compressed image,
a local decoding unit configured to generate a local decoded image of the compressed image,
a first reference image coding unit configured to store a first compressed frame generated by compressing the local decoded image by block in a first frame memory,
a first rate control unit configured to control the first reference image coding unit so that a code amount of the first compressed image is equal to or smaller than a first target code amount, and
a first reference image decoding unit con figured to expand the compressed frame and output an expanded frame to the video coding unit, wherein
the decoding apparatus includes
a video decoding unit configured to expand a compressed image to generate a decoded image,
a second reference image coding unit configured to store a second compressed frame generated by compressing the decoded image by block in a second frame memory,
a second rate control unit configured to control the second reference image coding unit so that a code amount of the second compressed frame is equal to or smaller than a second target code amount, and
a second reference image decoding unit configured to expand the second compressed frame and output an expanded frame to the video decoding unit, wherein
the first rate control unit determines whether overwrite occurs while the first compressed frame of a current frame is stored in the first frame memory, and changes intra-frame transition of the first target code amount when the overwrite occurs, and wherein
the second rate control unit determines whether the overwrite occurs while the second compressed frame of the current frame is stored in the second frame memory, and changes intra-frame transition of the second target code amount when the overwrite occurs.
